(19) United States
(12) Patent Application Publication
(10) Pub. No.: US 2013/0247446 A1
(43) Pub. Date: Sep. 26, 2013

(54) FISHING LURE

(71) Applicant: Ivo Coia, Niagara Falls (CA)

(72) Inventor: Ivo Coia, Niagara Falls (CA)

(21) Appl. No.: 13/849,773

(22) Filed: Mar. 25, 2013

Related U.S. Application Data
(60) Provisional application No. 61/615,585, filed on Mar. 26, 2012.

(51) Int. Cl. A01K 85/00

(52) U.S. Cl. CPC A01K 85/00
USPC 43/42.37; 43/42.49

(57) ABSTRACT

A fishing lure which includes a body and an eye for attaching a fishing line thereto. The eye is attached to the body. A hook is pivotally attached to the body and normally biased in a retracted position, the hook has a fully exposed hook end. In the retracted position when the line is oriented substantially along a vertical direction the hook shank is oriented substantially along a horizontal direction. The hook is capable of pivoting between a retracted position and a fully extended position.

This application claims priority from previously filed U.S. provisional patent application 61/615,585 filed Mar. 26, 2012 by Ivo Coia under the title FISHING LURE.

### FIELD OF THE INVENTION

The present invention relates to fishing lures. More specifically it relates to an improved jigging apparatus which includes a hook which is resiliently biased between a retracted position and a fully extended position.

### SUMMARY OF THE INVENTION

One of the more popular lures is commonly referred to as a jig. In it's simplest form the jig comprises a body or as it sometimes called a head which includes an eye attached to the head and a hook which is usually formed integrally therein. When fishing with a jig it is up to the fisherman to create the motion designed to attract the fish. This is usually done by moving the fishing rod back and forth or up and down allowing the lure to bounce and settle back to the bottom.

One of the challenges faced with fishing with a jig is the ability to be able to set the hook into the mouth of a fish. In many instances the fish will strike at the jig however due to incomplete or failure for the hook to set into the mouth of the fish often the fish escapes without being caught in the hook.

The present device the fishing lure described and depicted herein includes a resiliently biased hook which can extend from a retracted position to a fully extended position depending on the tension of the line thereby improving the possibility of the hook setting properly into the fishes mouth.

A fishing lure includes;
a) a body;
b) an eye for attaching a fishing line thereto, the eye attached to the body;
c) a hook is pivotally attached to the body and normally biased in a retracted position, the hook has a fully exposed hook end;
d) such that in the retracted position when the line is oriented substantially along a vertical direction the hook shank is oriented substantially along a horizontal direction;
e) wherein the hook is capable of pivoting between a retracted position and a fully extended position.

A fishing lure includes;
a) a body;
b) an eye for attaching a fishing line thereto, the eye attached to the body;
c) a hook is pivotally attached to the body and normally biased in a retracted position, the hook has a fully exposed hook end;
d) such that in the retracted position when the line is oriented substantially along a vertical direction the hook bend is oriented substantially along the vertical direction with the hook barb vertically above the hook shank.

Preferably such that in the retracted position when the line is oriented substantially along a vertical direction the hook barb is positioned vertically above the hook shank.

Preferably such that in the retracted position when the line is oriented substantially along a vertical direction the hook bend is oriented substantially along the vertical direction.

Preferably wherein the hook is capable of pivoting between a retracted position and a fully extended position.

Preferably wherein there is constant bias on the hook to return to the retracted position.

Preferably wherein the hook pivots to the fully extended position when a predetermined amount of tension is applied to the fishing line due to the presence of weight on the hook.

Preferably wherein in the fully extended position the hook shank is collinear with the fishing line.

Preferably wherein the fishing lure further includes a spring for applying bias to the hook shank relative to the body, the spring partially housed in a spring housing.

Preferably wherein the pivot pin mounted to the body and the hook mounted pivotally to the pivot pin.

Preferably wherein the spring partially wound around the pivot pin and partially wound around the hook shank.

Preferably wherein the angle between the fishing line and the hook shank is the retracted angle when the fishing lure in the retracted position.

Preferably wherein the retracted angle is between 80 and 100 degrees.

Preferably wherein the angle between the fishing line and the hook shank is the extended angle when the fishing lure in the extended position.

Preferably wherein the retracted angle is between 170 and 190 degrees.

### BRIEF DESCRIPTION OF THE DRAWINGS

With the intention of providing demonstration of the characteristics of the device or method, an example is given below, without any restrictive character whatsoever, with reference to the corresponding figures, of a preferred embodiment of the device and method as follows;

FIG. 1 is a side elevational view of the present device a lure shown in a retracted position in solid lines and in intermediate and fully extended positions in dashed lines;

FIG. 2 is a top plan view of the fishing lure shown in FIG. 1.

FIG. 3 is a cross-sectional view taken along lines AA of FIG. 1 showing the pivot pin and the spring housing.

FIG. 4 is a cross-sectional view taken along lines BB of FIG. 2 showing the spring housing and spring mounted onto the hook.

FIG. 5 is a top plan view of the spring.

FIG. 6 is a side elevational view of the spring.

FIG. 7 is a schematic representation of the present device a fishing lure deployed with a fishing line shown with a fishes mouth being set into the hook showing the lure in a fully extended position.

FIG. 8 is a schematic representation of the present device a fishing lure deployed with a fishing line shown with a fishes mouth being set into the hook showing the lure in an intermediate position.

FIG. 9 is a schematic representation of the present device a fishing lure deployed with a fishing line shown with a fishes mouth being set into the hook showing the lure in a retracted position.

FIG. 10 is a schematic representation of the present device a fishing lure deployed with a fishing line shown in a normal orientation relative to vertical just as a fishes mouth is biting into the hook showing the lure in a retracted position.

FIG. 11 is a schematic representation of the present device a fishing lure deployed with a fishing line shown with a fishes mouth being set into the hook showing the lure in an intermediate position.

FIG. 12 is a schematic representation of the present device a fishing lure deployed with a fishing line shown in a normal orientation with a fishes mouth set into the hook and tension applied to the fishing line as the fish is being reeled in and the weight of the fish pulls on the fishing line thereby placing the lure in a fully extended position.

### DESCRIPTION OF THE PREFERRED EMBODIMENTS

Referring now to the attached Figures the present device a lure 100 also known as a jig 102 includes the following components namely a body 104 which has an eye 106 mounted thereon and a hook 108. This geometry is known in the art however lure 100 further includes a spring 126 which is housed within a spring housing 130.

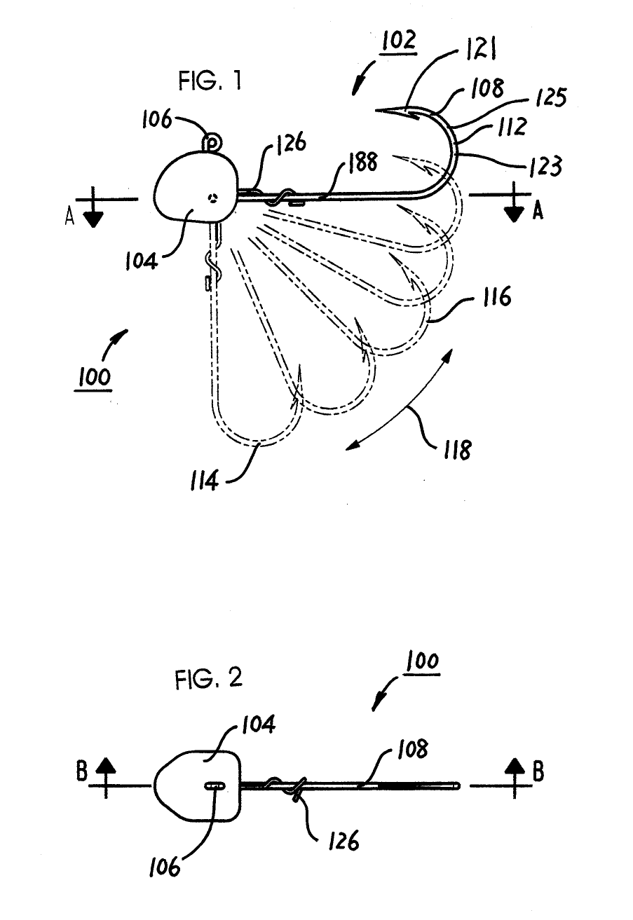

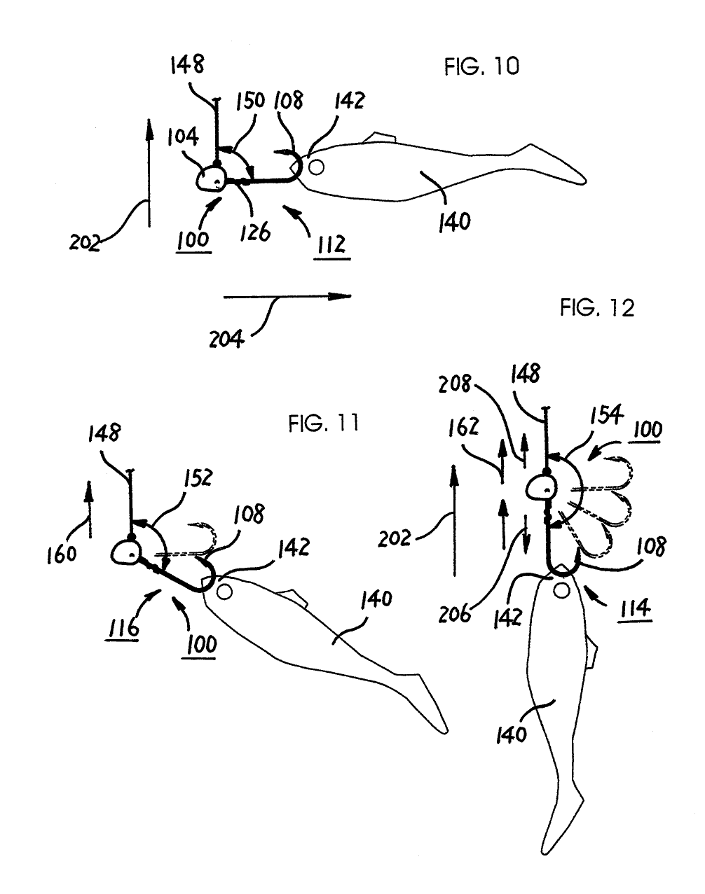

The hook 108 includes a shank 188 and as hook end 125 which includes a hook barb 121 and a hook bend 123. FIGS. 1 and 10 show the normal orientation of the lure when jigging in that the line 148 is roughly oriented along a vertical direction 202 and the hook shank is oriented along the horizontal direction 204.

Spring 126 provides for movement of hook 108 from a retracted position 112 through intermediate positions 116 to a fully extended position 114 by moving it through the pivot direction shown as 118. The hook normally is in the retracted position 112 and there is a constant bias on the hook 108 to return the hook to the retracted position 112. The hook end 125 is always fully exposed.

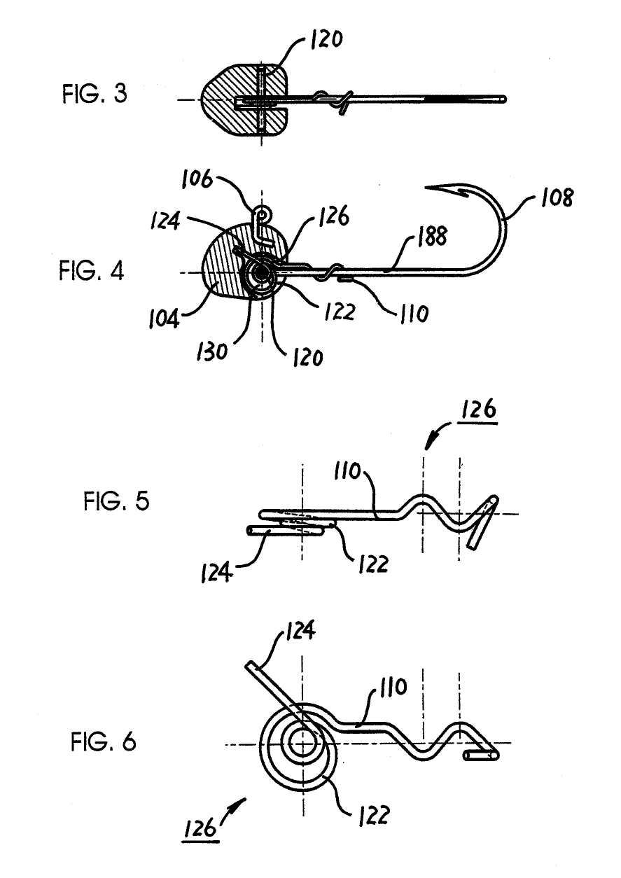

Referring now more specifically to FIGS. 3 through 6 spring 126 includes a coil portion 122 first arm 110 and a second arm 124.

The reader will note that spring 126 is mounted onto a pivot pin 120 and housed within spring housing 130 all housed within body 104. Second arm 124 simply held in position in spring housing 130 and first arm 110 is wrapped and/or coiled around the shank 188 of hook 108.

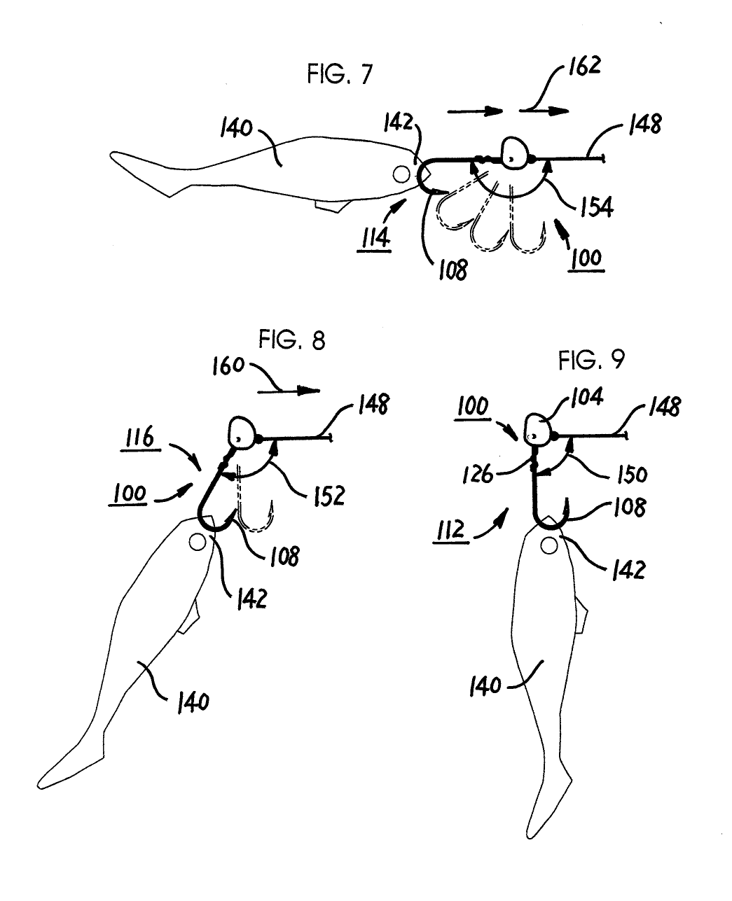

Referring now to the schematic FIG. 7 through 9 lure 100 is shown deployed with a fishing line 148 and a fish 140 have then bitten into hook 108 such that the fish's mouth 142 has set into hook 108.

First of all FIG. 9 shows lure 100 in retracted position 112 which is the position normally wherein the fish would first strike. The reader will note that the orientation of lure 100 also called jig 102 may be different than the orientation on the page shown in FIG. 9. In other words the shank 188 of hook 108 may be vertical to the bottom of the water and/or it may be oriented horizontally parallel to the bottom of the water or any position there between.

In any orientation a fish 140 would strike at lure 100 and the fishes mouth 142 would be partially hooked and/or caught by hook 108.

Once fishing line 148 is pulled due to the weight of fish 140 on the end of hook 108 hook 108 can pivot relative to body 104 into an intermediate position 116 as shown in FIG. 8 due to the initial pull 160 on fishing line 148.

Referring now to the schematic representation shown as FIG. 7 the fishes mouth 142 is fully set into hook 108 and the hook 108 can fully pivot into the extended position 114 due to the full pull 162 on fishing line 148. The reader will note that in the extended position 114 the fishing line 148 is parallel to the shank 188 of hook 108 and subtends in extended angle of 180 degrees shown as 154.

In the retracted position shown as 112 the angle between the fishing line 148 and the shank 188 of hook 108 is the retracted angle 150 shown as 90 degrees.

In other words hook 108 can pivot through pivot direction 118 to subtend an angle between 90 degrees and 180 degrees as measured between the fishing line 148 and the shank 188 of hook 108 as shown in FIGS. 7, 8 and 9.

It should be apparent to persons skilled in the arts that various modifications and adaptation of this structure described above are possible without departure from the spirit of the invention the scope of which defined in the appended claim.

I claim:

1. A fishing lure comprising;
a) a body;
b) an eye for attaching a fishing line thereto, the eye attached to the body;
c) a hook is pivotally attached to the body and normally biased in a retracted position, the hook has a fully exposed hook end;
d) such that in the retracted position when the line is oriented substantially along a vertical direction the hook shank is oriented substantially along a horizontal direction;
e) wherein the hook is capable of pivoting between a retracted position and a fully extended position.

2. A fishing lure comprising;
a) a body;
b) an eye for attaching a fishing line thereto, the eye attached to the body;
c) a hook is pivotally attached to the body and normally biased in a retracted position, the hook has a fully exposed hook end;
d) such that in the retracted position when the line is oriented substantially along a vertical direction the hook bend is oriented substantially along the vertical direction with the hook barb vertically above the hook shank.

3. The fishing lure claimed in claim 1 such that in the retracted position when the line is oriented substantially along a vertical direction the hook barb is positioned vertically above the hook shank.

4. The fishing lure claimed in claim 3 such that in the retracted position when the line is oriented substantially along a vertical direction the hook bend is oriented substantially along the vertical direction.

5. The fishing lure claimed in claim 2 wherein the hook is capable of pivoting between a retracted position and a fully extended position.

6. The fishing lure claimed in claim 1 wherein there is constant bias on the hook to return to the retracted position.

7. The fishing lure claimed in claim 5 wherein there is constant bias on the hook to return to the retracted position.

8. The fishing lure claimed in claim 6 wherein the hook pivots to the fully extended position when a predetermined amount of tension is applied to the fishing line due to the presence of weight on the hook.

9. The fishing lure claimed in claim 1 wherein in the fully extended position the hook shank is collinear with the fishing line.

10. The fishing lure claimed in claim 5 wherein in the fully extended position the hook shank is collinear with the fishing line.

11. The fishing lure claimed in claim 1 wherein the fishing lure further includes a spring for a applying bias to the hook shank relative to the body, the spring partially housed in a spring housing.

12. The fishing lure claimed in claim 11 wherein the pivot pin mounted to the body and the hook mounted pivotally to the pivot pin.

13. The fishing lure claimed in claim 12 wherein the spring partially wound around the pivot pin and partially wound around the hook shank.

14. The fishing lure claimed in claim 1 wherein the angle between the fishing line and the hook shank is the retracted angle when the fishing lure in the retracted position.

15. The fishing lure claimed in claim 14 wherein the retracted angle is between 80 and 100 degrees.

16. The fishing lure claimed in claim 1 wherein the angle between the fishing line and the hook shank is the extended angle when the fishing lure in the extended position.

17. The fishing lure claimed in claim 16 wherein the retracted angle is between 170 and 190 degrees.
